(19) United States
(12) Patent Application Publication
(10) Pub. No.: US 2002/0119388 A1
(43) Pub. Date: Aug. 29, 2002

(54) Manufacturing method for electrophotography photosensitive body

(76) Inventor: Hirotaka Kobayashi, Nagano (JP)

Correspondence Address: MORRISON LAW FIRM, 145 North Fifth Avenue, Mt. Vernon, NY, 10550, US

(21) Appl. No.: 10/005,912

(22) Filed: Dec. 4, 2001

(30) Foreign Application Priority Data
Dec. 8, 2000 (JP) 2000-374481

(51) Int. Cl. G03G 5/047

(52) U.S. Cl. 430/133; 430/134

(57) ABSTRACT

A method for manufacturing an electrophotography photosensitive body coats a charge generating layer on a conductive substrate and a charge transport layer on the charge generating layer. The charge generating layer is formed using a coating solution includes a charge generating substance, a binding resin and a solvent. The charge transport layer is formed using a second coating solution including a charge transport substance, a binding resin and a solvent.

### BACKGROUND OF THE INVENTION

1. Field of the Invention

The present invention relates to an electrophotography photosensitive body (henceforth referred to as photosensitive body). The present invention further relates to a method for manufacturing an organic electrophotography photosensitive body. Organic electrophotography photosensitive bodies are used in image forming devices, electrostatic copiers, and laser beam printers.

2. Description of the Related Art

An electrophotography photosensitive body includes a photosensitive layer formed on a conductive substrate (hereinafter referred to as a substrate). The photosensitive layer performs a photoconductive function, as will be explained.

To operate effectively, the photosensitive body must include multiple functions. These functions include, retaining surface charge in the dark, generating charge by receiving light, and transporting the generated charge by receiving light.

There exist single-layer photosensitive bodies having a single photosensitive layer capable of all of these functions.

There also exist function-separated layered photosensitive bodies having a charge generating layer and a charge transport layer. The charge generating layer functions for charge generation during light-receiving times. The charge transport layer functions for retaining surface charge in the dark and transporting the charge generated by the charge generating layer during light receiving times.

In recent years, due to advantages in materials, production capabilities, and safety, there has been active research and development in organic electrophotography photosensitive bodies.

These bodies use organic compounds as the functional component in charge generation and transport. At present there has been only moderate progress in their use in copiers and printers.

The general method for manufacturing a photosensitive body is to form the photosensitive layer on top of a conductive substrate by coating and drying a coating solution containing binding resin and functional materials. The coating solution is produced by dissolving or dispersing binding resin and functional material in an appropriate organic solvent. The organic solvent, used in environmental consideration, is frequently a de-halogenated solvent. In particular, tetrahydrofuran, 1,3 dioxolane, cyclohexanone are used as solvents. These solvents have excellent volatility and excellent solubility of binding resins and are commonly used.

In organic photosensitive bodies, a high efficiency photosensitive layer is generally formed by combining various materials. As an unfortunate result, the solvent for the coating solution must be include various qualities, such as suitable volatility, and good solubility and dispersibility with the various binding resins and functional materials.

Attempts have be been made to create a better performing photosensitive body by using a mixture of solvents which combines solvents used in the prior art.

For example, in Japanese Laid Open Patent Publication Number 8-297372, the object was to provide an organic photosensitive body with excellent production qualities and durability even with a thick photosensitive layer. This combination forms a good image that is stable over the long term.

As a solvent including a mixture solvent of dioxolane and a solvent with a saturation vapor pressure of 100 mmHg. or greater is satisfactory in terms of both compatibility with polycarbonate resin (used as a binder resin in the photosensitive layer) and in terms of shelf life for the coating solution for forming the photosensitive layer. This solvent mixture contains dioxolane at 10-60 weight %.

The following is a problem particular to laminated photosensitive bodies. During manufacturing, since a plurality of functional layers are sequentially formed on a conductive substrate, the organic solvent(s) used in the coating solution(s) for each functional layer may collaterally affect another precedent or subsequent functional layer. This collateral affect negatively impacts the performance of the photosensitive body.

In Japanese Laid-Open Patent Publication Number 7-36198, to prevent the dislocation of a crystal system of a specific phthalocyanine compound used as the charge generating substance, toluene alone or a mixture solvent of toluene and 1,4-dioxane is used as a solvent for the coating solution in the charge transport layer.

The above-described techniques are effective only in relation to specific functional materials.

In general, for a layered photosensitive body with a charge generating layer and a charge transport layer, the above-described solvents do not remove the problems associated with the coating solution organic solvent used in layer formation.

For example, when tetrahydrofuran, 1,3-dioxolane, cyclohexanone is used as the solvent for the charge transport layer coating solution, dissolving power is very strong. Depending on the type of binding resin used in the charge generating layer, the binding resin may be dissolved, and this may result in the dissolving-out of the charge generating layer, and poor outer appearance.

Even if there is no resulting degradation of the outer appearance, when dip coating is used as a coating method, the charge generating layer components may dissolve-out into the charge transport layer coating solution.

Due to the accumulation of charge generating layer components, the electrical properties and repeat quality in the actual machine are negatively affected.

In other words the above-described problems have not been resolved concerning the coating solution solvent and the technology for creating a photosensitive body with good performance.

### OBJECTS AND SUMMARY OF THE INVENTION

It is an object of the present invention to provide a remedy for the above-described problems.

It is another object of the present invention to provide a manufacturing method for an electrophotography photosensitive body.

It is another object of the present invention to provided a manufacturing method in which a coating solution solvent, used for layer formation, enables a photosensitive body.

It is another object of the present invention to provide a manufacturing method that allows creating of a photosensitive body with good performance without dissolving of the charge generating layer and without dissolving-out the functional components of the charge generating layer into the charge transport layer.

It is another object of the present invention to provide a coating solution for a charge transport layer that so substantially prevents dissolution of a charge generating layer, even after dip coating a total area of 2500 m² or more, that there is no effectively detectable charge generating layer in the coating solution.

It is another object of the present invention to provide a method where the solvent for the coating solution of the charge transport layer is a mixture solvent of 1,3 dioxolane and toluene, the mixture amount of the toluene being preferably 10-80 weight %.

It is another object of the present invention to provide a method wherein the binding resin for the charge generating layer preferably includes a vinyl chloride copolymer resin.

The present invention relates to a method for manufacturing an electrophotography photosensitive body in which a coating solution solvent for a charge transport layer provides a superior photosensitive body and prevents dissolution of the charge generating layer's functional components into the charge transport layer. The present method forms a charge transport layer on top of a charge generating layer. The charge generating layer is formed using a coating solution including a charge generating substance, a binding resin and a solvent. The charge transport layer is formed using a second coating solution including a charge transport substance, a binding resin and a solvent.

According to an embodiment of the present invention there is provided a manufacturing method for an electrophotography photosensitive body comprising the steps of forming at least a charge generation layer on at least a conductive substrate, the charge generation layer is formed using a first coating solution containing at least a first charge generating substance, a first binding resin, and a first solvent, forming at least a charge transport layer on top of the charge generation layer, the charge transport layer is formed using a second coating solution containing at least a second charge transport substance, a second binding resin, and a second solvent, and the second solvent being a solvent effective to prevent a dissolution of the charge generation layer into the charge transportation layer during the step of forming at least a charge transport layer.

According to another embodiment of the present invention there is provided a manufacturing method, wherein: the second solvent is a mixture solvent, and the mixture solvent containing at least 1,3 dioxolane and toluene, whereby the dissolution is minimized.

According to another embodiment of the present invention there is provided a manufacturing method, wherein: the mixture solvent contains toluene in from 10 to 80 weight %.

According to another embodiment of the present invention there is provided a manufacturing method, wherein: the mixture solvent contains toluene in from 10 to 50 weight %.

According to another embodiment of the present invention there is provided a manufacturing method, wherein: the first binding resin includes at least a vinyl chloride copolymer resin.

According to another embodiment of the present invention there is provided a manufacturing method, wherein: the charge transport layer includes an oxidation inhibiting agent, whereby the electrophotography photosensitive body increases in chemical, thermal, and optical stability.

According to another embodiment of the present invention there is provided a manufacturing method, wherein: the step of forming the charge transport layer forms the charge transport layer in a first film thickness, and the first film thickness from 3 to 50 micrometers.

According to another embodiment of the present invention there is provided a manufacturing method, wherein: the first film thickness is preferably from 10 to 40 micrometers.

According to another embodiment of the present invention there is provided a manufacturing method, wherein: the second coating solution prevents transport of the first charge generating substance from the charge generating layer to the charge transport layer even after the second coating solution has coated a total area of 2500 meters square during the step of forming the charge transport area.

According to another embodiment of the present invention there is provided a method for manufacturing an electrophotography photosensitive body, comprising the steps of: forming at least a charge generation layer on at least a conductive substrate, the charge generation layer is formed using a first coating solution containing at least a first charge generating substance, a first binding resin, and a first solvent, forming at least a charge transport layer on top of the charge generation layer, the charge transport layer is formed using a second coating solution containing at least a second charge transport substance, a second binding resin, and a second solvent, the second solvent being a solvent effective to prevent a dissolution of the charge generation layer into the charge transportation layer during the step of forming at least a charge transport layer, the second solvent being a mixture solvent, and the mixture solvent containing at least 1,3 dioxolane and toluene, whereby the dissolution is minimized.

According to another embodiment of the present invention there is provided a method for manufacturing an electrophotography photosensitive body, comprising the steps of: forming at least a charge generation layer on at least a conductive substrate, the charge generation layer is formed using a first coating solution containing at least a first charge generating substance, a first binding resin, and a first solvent, forming at least a charge transport layer on top of the charge generation layer, the charge transport layer is formed using a second coating solution containing at least a second charge transport substance, a second binding resin, and a second solvent, the second solvent being a solvent effective to prevent a dissolution of the charge generation layer into the charge transportation layer during the step of forming at least a charge transport layer, the second solvent being a mixture solvent, the mixture solvent containing at least 1, 3 dioxolane and toluene, and the mixture solvent contains toluene in from 10 to 80 weight %, whereby the dissolution is minimized.

According to another embodiment of the present invention there is provided an electrophotography photosensitive body manufacturing method, including processes for forming at least a charge generating layer and a charge transport layer on top of a conductive substrate, wherein: the charge generating layer is formed using a first coating solution containing at least a first charge generating substance, a first binding resin, and a first solvent, the charge transport layer is formed using a second coating solution containing at least a second charge transport substance, a second binding resin, and a second solvent, and the second solvent for the second coating solution being a solvent which prevents dissolution of the charge generating layer into the second coating solution of the charge transport layer during the process of forming the charge transport layer.

According to another embodiment of the present invention there is provided a manufacturing method, wherein: the first charge generating substance of the charge generating layer surface is not detected from the second coating solution of the charge transport layer even after conducting a dip coating of the charge transport layer onto a total area of 2500 m² or greater of the charge generating layer surface.

According to another embodiment of the present invention there is provided a manufacturing method, wherein: the second solvent for the second coating solution for the charge transport layer is a mixture solvent of 1,3 dioxolane and toluene, and a mixture amount of the toluene in the mixture solvent is 10-80 weight %.

According to another embodiment of the present invention there is provided a manufacturing method, wherein: the first binding resin for the charge generating layer includes at least a vinyl chloride copolymer resin.

The above, and other objects, features and advantages of the present invention will become apparent from the following description read in conjunction with the accompanying drawings, in which like reference numerals designate the same elements.

### BRIEF DESCRIPTION OF THE FIGURE

FIG. 1 is a cross-sectional diagram of a negative charge function separated electrophotography photosensitive body.

### DETAILED DESCRIPTION OF THE INVENTION

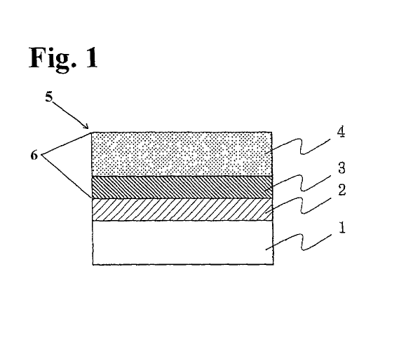

Referring now to FIG. 1, one embodiment of a photosensitive body 5 includes a conductive substrate 1. An undercoat layer 2 is coated on conductive substrate 1. Undercoat layer 2 serves as an interface between conductive substrate 1 and a photosensitive layer 6, as will be described.

Photosensitive body 5 is a function separated type of body where photosensitive layer 6 includes a charge generating layer 3 and a charge transport layer 4. Charge generating layer 3 and charge transport layer 4 are formed sequentially on top of under coat layer 2.

Photosensitive body 5 and photosensitive layer 6 are referred to as a ‘negative charge type’ since charge transport layer 4 is layered on top of charge generating layer 3.

Although not shown, an additional surface protection layer may be formed over charge transport layer 4 to provide additional mechanical protection to photosensitive body 5.

Charge generating layer 3 is formed using a coating solution containing at least a charge generating substance, a binding resin, and a solvent, as will be described.

Charge transport layer 4 is formed using a coating solution containing at least a charge generating substance, a binding resin, and a solvent, as will also be described.

During formation charge generating layer 3 and charge transport layer 4 are formed on undercoat layer 2 using standard coating methods.

During formation of charge transport layer 4, selection of a coating solution solvent is important to success. The coating solution solvent used in forming charge transport layer 4 must be a material which prevents substantial dissolution and transport of charge generating substances into charge transport layer 4. When properly selected, the coating solution solvent effectively prevents inappropriate migration of charge generating substances from charge generating layer 3 into charge transport layer 4.

In other words, the binding resin for charge generating layer 3 must not be dissolved by the charge transport layer 4 coating solution. When such dissolution is prevented, the charge generating substances of charge generating layer 3 do not dissolve in the coating solution for charge transport layer 4.

As an important benefit, when such dissolution is prevented during the formation process of charge transport layer 4, poor visual appearance does not occur.

As an additional important benefit, when such dissolution is prevented there is no functional impairment of charge transport layer 4. Since there is no functional impairment of charge transport layer 4, there is no deterioration in electrical qualities or repeat fatigue, and a high performance photosensitive body 5 is easily obtained.

During manufacture or testing, an ultraviolet and visible light spectrophotometer (UV-3100 PC manufactured by Shimazu Seisakujo, for example) is used to determine the effective ‘dissolving-out’ of charge generating substances into charge transport layer 4. Using this method, a reflectance of the charge transport layer coating solution is measured. If a peak for charge generating substance is detected, it is determined that there has been dissolving out of the charge generating substance.

As noted above, the formation of charge transport layer 4 involves a coating solution containing at least a charge transport substance, a binding resin and a solvent. As above, with this combination, a film is formed by standard coating methods. Where dip coating is used as the standard coating method, since the charge generating substance (a dissolved component of charge generating layer 3) is easily mixed in the coating solution for charge transport layer 4, there may be deterioration of the quality of photosensitive body 5. In sum, where mixing occurs, the charge generating substance pollutes charge transport layer 4 and negatively impacts its performance.

As a specific example, when conducting standard dip coating with a 1000 liter scale chamber, where charge transport layer 4 is formed with an average film thickness of around 30 micrometers on top of the film forming surface of charge generating layer 3, a total area of 2500 m² of charge transport layer 4 is formed until the coating solution is completely used up.

To maintain a good coating quality until the end of each coating cycle, components of charge generating layer 3 must not dissolve into the coating solution for charge transport layer 4, even when coating charge generating layer 3 with a total area of greater than 2500 m². Coating solution temperatures are 15-35 degrees C. and preferably from 20-30 degrees C. Dipping times are usually at 5 minutes or greater for an area of approximately 2500 m², but may vary depending upon processing area, temperature, production needs, and other factors.

Thus, charge generating substances contained in charge generating layer 3 are preferably not detectable in the coating solution of charge transport layer 4 after manufacture at temperatures of 15-35 degrees C., at dipping times of 5 minutes more, and after coating areas of 2500 m² or more.

A mixture solvent of 1,3 dioxolane and toluene are effective as a coating solvent for charge transport layer 4 and suitably operates in the above conditions.

The mixing amount of toluene in the mixture solvent is preferably 10-80 weight %, and more preferably 10-50 weight %. By using a solvent of this composition as the sole solvent, in contrast to 1,3 dioxolane and others, the dissolving of charge generating layer 3, and the dissolving of charge generating substances into charge transport layer 4 is prevented.

Using the above-described mixture solvent, a good coating appearance is achieved. As a further result, a high performance electrophotography photosensitive body is easily manufactured, without deterioration in charging quality) dark attenuation quality, or electrical properties during repeated use.

As described above, the film formation of charge generating layer 3, charge transport layer 4 (and possibly a protective coating) can be generally conducted with standard formation methods.

In other words, using a known formation method such as a paint shaker, ball mill, sand mill, or ultrasonic wave dispersion, a coating solution is created by dissolving or dispersing the mixture material of each layer together with a suitable solvent, and with regard to charge transport layer 4, a solvent which satisfies the above-described conditions.

After film formation using known methods (the dip method, the spray coating method, and the bar code method) a drying process is conducted to form a uniform photosensitive layer 6 by vaporizing the solvent(s) in each of the functional layers. The drying process may include a drying oven with a standard heater or the film may be vacuum dried without changing temperature. The decision on which type of drying process to use is a processing decision.

After formation, conductive substrate 1 functions as an electrode for photosensitive body 5. Conductive substrate 1 additionally functions as a support body for each of the remaining other layers.

Depending upon processing an manufacturing demands, conductive substrate 1 may have any required shape, such as a tube, a plate, or a film, and may be any reasonably functional material or composition such as a metal (aluminum, stainless steel, or nickel, etc.), a ceramic such as glass, or a composition such as resin. The important factor is that conductive substrate 1 meets the manufacturing and processing needs and accepts the above-described conductive treatment.

Undercoat layer 2 is a layer having a main component of resin or of an oxide film such as alumite. Undercoat layer 2 is provided to photosensitive body 5 to fulfill multiple objectives. These objectives include prevention of injection of unnecessary charge to photosensitive layer 6 from conductive substrate 1, improvement of a defective coating on the substrate surface, and improvement of adhesion of photosensitive layer 6 to conductive substrate 1.

When resin is a main component of undercoat layer 2, polyethylene, polypropylene, polystyrene, acrylic resin, vinyl chloride resin, vinyl acetate resin, polyurethane resin, epoxy resin, polyester resin, melamine resin, silicon resin, polyvinyl butyral resin, polyamide resin, and their copolymers may be combined and used.

Furthermore, metal oxide particles may be additionally combined in the resin. The metal-oxide particles may include SiO₂, TiO₂, In₂O₃, ZrO₂, and others.

Charge generating layer 3 is formed by coating a coating solution onto undercoat layer 2 and conductive substrate 1. The coating solution of charge generating layer 3 includes particles of organic photoconductive substances (charge generating substances) dispersed in a binding resin.

During operation, charge generating layer 3 receives light and generates charge. For effective operation of charge generating layer 3, it is important to have a high charge generating efficiency and, at the same time, maintain the injection quality of the charge to charge transport layer 4. It is preferable that the electric field dependence is low, and that the injection remain effective even at low electric fields.

Since charge generating layer 3 has a charge generating function, its film thickness is determined by the light absorption coefficient of the charge generating substance. In general, charge generating layer 3 has a film thickness is 5 micrometers or less, and preferably 1 micrometers or less.

The charge generating substances may include phthalocyanine pigments (such as titanyl oxyphthalocyanine, and amorphous titanyl phthalocyanine), polycyclic quinone pigments (such as anthanthrone), perylene pigments, perinone pigments, squarilium pigments, thiapyrylium pigments, and quinacrylidone pigments. These pigments maybe combined to increase operational effectiveness and other processing demands.

The binding resin may include polycarbonate resin, polyester resin, polyamide resin, polyurethane resin, epoxy resin, polyvinyl butyral resin, polyvinyl acetal resin, vinyl chloride resin, phenoxy resin, silicon resin, ester methacrylate resin, and their copolymers alone or in combination. Preferably, a vinyl chloride copolymer resin is used.

Although the charge generating substance is the main part of charge generating layer 3, a charge transport substance may also be added where demanded by process performance criteria.

Charge transport layer 4 is a coating film in which a charge transport substance is dispersed in a binding resin. In the dark, the coating film operates to retain the charge of the photosensitive body as an insulating layer, but during light receiving times, it exhibits the function of transporting charge injected from charge generating layer 3.

A standard oxidation inhibiting agent may also be added to charge transport layer 4 in addition to the main components of the charge transport substance and the binding resin described above. The standard oxidation inhibiting agent operates to improve stability of photosensitive body 5 with respect to ozone, light, and heat.

In the present embodiment, for every 100 weight parts of the sum of the charge transport substance and binding resin, the addition amount of the oxidation inhibiting agent is preferably 0.001-10 weight parts, and more preferably in the range of 0.005-5 weight parts.

To maintain an effective surface electric potential, the film thickness of charge transport layer 4 is preferably in the range of 3-50 micrometers, and more preferably 10-40 micrometers.

In charge transport layer 4, the charge transport substance may include hydrazone compounds, styryl compounds, benzydyne compounds, stilbene compounds, pyrazoline compounds, pyrazolone compounds, oxadiazole compounds, other amine compounds, and charge transporting polymers such as polyvinyl carbazole.

Mechanical, chemical and electrical stability, the adhesion quality, as well as compatibility with the charge transport substance are important in the binding resin in charge transport layer 4. Polymers and copolymers of polycarbonate resin, polyester resin, polystyrene resin, ester methacrylate, and others may be used for the binding resin.

As noted above, a surface protective layer maybe added to photosensitive body 5 as required by production and customer needs. The surface protective layer should be constructed from a substance that has excellent durability with respect to mechanical stress and is chemically stable.

In the dark, the surface protective layer has the function of accepting and retaining charge from a corona discharge. In addition, the surface protective layer must have the capability of transmitting light that induces charge generating layer 3.

During light exposure times, the surface protective layer transmits light and allows the light to reach charge generating layer 3. During these times, the surface protective layer receives injection of the generated charge and must neutralize and eliminate the surface charge.

The film thickness of the surface protective layer generally depends on its composition, but the film thickness can be set as appropriate within a range that minimizes negative effects and minimizes residual electric potential with repeated continuous use.

The surface protective layer may be constructed from polyvinyl butyral resin, polycarbonate resin, nylon resin, polyurethane resin, polyallylate resin, modified silicon resins of acryl modified silicon resin, epoxy modified silicon resin, alkyd modified silicon resin, polyester modified silicon resin, urethane modified silicon resin. The surface protective layer may also include a hard coat agent of silicon resin or other material.

These modified silicon resins described above may be used alone, or to improve durability, may include a mixture product with a condensate of a metal alkoxy compound that forms a coating, the coating having a main component of SiO₂, TiO₂, In₂O₃, ZrO₂, or other suitable material.

Furthermore, in each functional layer described above, for improving sensitivity, reducing residual electric potential, and reducing quality fluctuations during repeated use, an electron accepting substance can be added as needed.

Examples of electron accepting substances include compounds with large electron affinities include succinic anhydride, maleic anhydride, dibromo succinic anhydride, phthalic anhydride, 3-nitro phthalic anhydride, 4-nitro phthalic anhydride, pyromellitic anhydride, pyrolmellitic acid, trimellitic acid, trimellitic anhydride, phthalimide, 4-nitro phthalimide, tetracyanaoethylene, tetracyanoquinodimethane, chloranyl, bromanyl, o-nitrobenzoic acid, and others.

Below, the present invention is more fully described using alternative embodiments. It should be understood by the reader that the present invention is not limited to the alternative embodiments shown.

In the following examples, broken into individual groups, “parts” refer to weight parts and “%” refer to weight %.

### Photosensitive Body Group 1

### Photosensitive Body Test Example 1-1

Conductive substrate 1 was an aluminum pipe having an outer diameter of 30 mm and a length of 260 mm. An undercoat layer coating solution with the following composition was coated onto conductive substrate 1 using a dip coating device. The result was dried for 30 minutes under normal pressure at 135 degrees C and then cooled. An undercoat layer 2 of film thickness 0.5 micrometers was formed.

| | |
|---|---|
| Alcohol soluble nylon (CM8000, manufactured by Toray Corp.) | 5 parts |
| Titanium oxide fine particles treated with amino silane | 5 parts |
| Mixture solvent of methanol, methylene chloride (6/4) | 90 parts |

Next, a charge generating layer coating solution with the following composition was coated using a dip coating device. This resultant was dried under normal pressure at 80 degrees C. for 30 minutes, and this was cooled to form a charge generating layer 3 of film thickness 0.3 micrometers.

| | | |
|---|---|---|
| Titanyl oxyplithalocyanine | 1 | part |
| Vinyl chloride copolymer resin | 1 | part |
| (MR-110, manufactured by Nihon Zeon Corp.) | | |
| Methylene chloride | 98 | parts |

Next, a charge transport layer coating solution with the following composition was coated using a dip coating device. The resultant was dried at normal pressure at 120 degrees C. for 60 minutes and cooled to form a charge transport layer 4 of a film thickness of 25 micrometers.

| | |
|---|---|
| Stilbene compound | 2 parts |
| (compound represented by the Formula (I)) | |
| Polycarbonate resin (TS2050, manufactured by Teijin Kasei) | 10 parts |
| Mixture solvent of 1,3 dioxolane and toluene (100/0) | 80 parts |

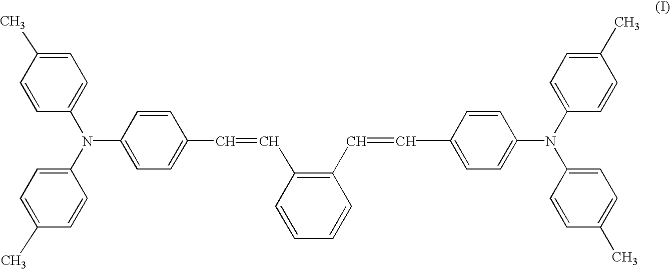

The electrophotography photosensitive body was manufactured as described above.

### Photosensitive Body Test Examples 1-2 Through 1-6

In the present example, photosensitive bodies 5 were created in the same manner as photosensitive body test example 1-1, except that the solvent compositions for the charge transport layer coating solution were changed as shown below in Table 1.

### Photosensitive Body Group 2

### Photosensitive Body Test Example 2-1

In the present example, a photosensitive body 5 was created in the same manner as photosensitive body test example 1-1, except that the composition of the charge generating layer coating solution was changed to the following.

| | | |
|---|---|---|
| Amorphous titanyl phthalocyanine | 1 | part |
| Butyral resin | 1 | part |
| (Eslek BX-1, manufactured by Sekisni Kagaku) | | |
| Methylene chloride | 98 | parts |

### Photosensitive Body Test Examples 2-2 Through 2-6

In these examples, photosensitive bodies 5 were created in the same manner as photosensitive body test example 2-1, except that the solvent compositions for the charge transport layer coating solution were changed as shown below in Table 1.

### Photosensitive Body Group 3

### Photosensitive Body Test Example 3-1

A photosensitive body was created in the same manner as photosensitive body test example 1-1, except that a mixture solvent of tetrahydrofuran and toluene (100/0) was used as the solvent for the charge generating layer coating solution.

### Photosensitive Body Test Examples 3-2 Through 3-6

Photosensitive bodies were created in the same manner as photosensitive body test example 3-1, except that the solvent compositions for the charge transport layer coating solution were changed as shown below in Table 1.

### Photosensitive Body Group 4

### Photosensitive Body Test Example 4-1

A photosensitive body 5 was created in the same manner as photosensitive body test example 2-1, except that a mixture solvent of tetrahydrofuran and toluene (100/0) was used as the solvent for the charge generating layer coating solution.

### Photosensitive Body Test Examples 4-2 Through 4-6

Photosensitive bodies 5 were created in the same manner as photosensitive body test example 4-1, except that the solvent compositions for the charge transport layer coating solution were changed as shown below in Table 1.

### Photosensitive Body Group 5

### Photosensitive Body Test Example 5-1

A photosensitive body was created in the same manner as photosensitive body test example 1-1, except that a mixture solvent of cyclohexanone and toluene (100/0) was used as the solvent for the charge generating layer coating solution.

### Photosensitive Body Test Examples 5-2 Through 5-6

Photosensitive bodies were created in the same manner as photosensitive body test example 5-1, except that the solvent compositions for the charge transport layer coating solution were changed as shown below in Table 2.

### Photosensitive Body Group 6

### Photosensitive Body Test Example 6-1

A photosensitive body was created in the same manner as photosensitive body test example 2-1, except that a mixture solvent of cyclohexanone and toluene (100/0) was used as the solvent for the charge generating layer coating solution.

### Photosensitive Body Test Examples 6-2 Through 6-6

Photosensitive bodies were created in the same manner as photosensitive body test example 6-1, except that the solvent compositions for the charge transport layer coating solution were changed as shown below in Table 2.

### Photosensitive Body Group 7

### Photosensitive Body Test Example 7-1

A photosensitive body was created in the same manner as photosensitive body test example 1-1, except that a mixture solvent of tetrahydropyran and toluene (100/0) was used as the solvent for the charge generating layer coating solution.

### Photosensitive Body Test Examples 7-2 Through 7-6

Photosensitive bodies were created in the same manner as photosensitive body test example 7-1, except that the solvent compositions for the charge transport layer coating solution were changed as shown below in Table 2.

### Photosensitive Body Group 8

### Photosensitive Body Test Example 8-1

A photosensitive body was created in the same manner as photosensitive body test example 2-1, except that a mixture solvent of tetrahydropyran and toluene (100/0) was used as the solvent for the charge generating layer coating solution.

### Photosensitive Body Test Examples 8-2 Through 8-6

Photosensitive bodies were created in the same manner as photosensitive body test example 8-1, except that the solvent compositions for the charge transport layer coating solution were changed as shown below in Table 2.

During the formation of the above examples and the solvent of the charge transport layer coating solution, the ‘dissolving-out’ of charge generating substance and the solubility of the charge transport layer binding resin were determined using the photosensitive body test examples as described above. The results from these tests are shown in the following Tables 1 and 2.

As above, an ultraviolet light and visible light spectrophotometer UV-3100 PC manufactured by Shimazu Seisakujo was used for the detection of the charge generating substance. The detection of the charge generating substance was conducted by measuring the reflectance of the charge transport layer coating solution after conducting dip coating with respect to a charge generating layer surface of a total area of 2500 m² at room temperature. When a peak was observed near 780 nm, it was determined that charge generating substance was mixed into charge transport layer coating solution.

Evaluation, concerning the solubility of the solvent used in each text example compared to the charge transport resin, was also conducted with regard to a polycarbonate resin (BPPC5 manufactured by Idemitsu Kosan Corp. Ltd.) as another binding resin The results from this evaluation are shown in both the following Tables 1 and 2.

TABLE 1

| | | Dissolving out of charge | | | | | | |
|---|---|---|---|---|---|---|---|---|
| | | generating substance | | | | | | |
| | | Binding resin for charge | | | | | | |
| | | generating layer | | | | Solubility | | |
| | | MR110 | | BX-1 | | Binding resin for | | |
| | | Photo- | | Photo- | | charge transport layer | | |
| | | sensitive | | sensitive | | TS2050 | BPPC5 | Total |
| | | body test ex. | Evaluation | body test ex. | Evaluation | Evaluation | Evaluation | Evaluation |
| 1,3 dioxolane/toluene | 100/0 | 1-1 | Δ | 2-1 | ◯ | ◯ | ◯ | Δ |
| | 90/10 | 1-2 | ◯ | 2-2 | ◯ | ◯ | ◯ | ◯ |
| | 70/30 | 1-3 | ◯ | 2-3 | ◯ | ◯ | ◯ | ◯ |
| | 50/50 | 1-4 | ◯ | 2-4 | ◯ | ◯ | ◯ | ◯ |
| | 20/80 | 1-5 | ◯ | 2-5 | ◯ | ◯ | ◯ | ◯ |
| | 0/100 | 1-6 | ◯ | 2-6 | ◯ | ◯ | X | X |
| tetrahydro furan/toluene | 100/0 | 3-1 | X | 4-1 | ◯ | ◯ | ◯ | X |
| | 90/10 | 3-2 | X | 4-2 | ◯ | ◯ | ◯ | X |
| | 70/30 | 3-3 | X | 4-3 | ◯ | ◯ | ◯ | X |
| | 50/50 | 3-4 | X | 4-4 | ◯ | ◯ | ◯ | X |
| | 20/80 | 3-5 | Δ | 4-5 | ◯ | ◯ | Δ | Δ |
| | 0/100 | 3-6 | ◯ | 4-6 | ◯ | ◯ | X | X |

TABLE 2

| | | Dissolving out of charge | | | | | | |
|---|---|---|---|---|---|---|---|---|
| | | generating substance | | | | | | |
| | | Binding resin for charge | | | | | | |
| | | generating layer | | | | Solubility | | |
| | | MR110 | | BX-1 | | Binding resin for | | |
| | | Photo- | | Photo- | | charge transport layer | | |
| | | sensitive | | sensitive | | TS2050 | BPPC5 | Total |
| | | body test ex. | Evaluation | body test ex. | Evaluation | Evaluation | Evaluation | Evaluation |
| cyclohexanone/toluene | 100/0 | 5-1 | X | 6-1 | ◯ | ◯ | ◯ | X |
| | 90/10 | 5-2 | X | 6-2 | ◯ | ◯ | ◯ | X |
| | 70/30 | 5-3 | X | 6-3 | ◯ | ◯ | ◯ | X |
| | 50/50 | 5-4 | X | 6-4 | ◯ | ◯ | ◯ | X |
| | 20/80 | 5-5 | Δ | 6-5 | ◯ | ◯ | Δ | Δ |
| | 0/100 | 5-6 | ◯ | 6-6 | ◯ | ◯ | X | X |
| tetrahydropyran/toluene | 100/0 | 7-1 | X | 8-1 | ◯ | ◯ | ◯ | X |
| | 90/10 | 7-2 | X | 8-2 | ◯ | ◯ | ◯ | X |
| | 70/30 | 7-3 | X | 8-3 | ◯ | ◯ | ◯ | X |
| | 50/50 | 7-4 | X | 8-4 | ◯ | ◯ | ◯ | X |
| | 20/80 | 7-5 | Δ | 8-5 | ◯ | ◯ | Δ | Δ |
| | 0/100 | 7-6 | ◯ | 8-6 | ◯ | ◯ | X | X |

In Tables 1 and 2, the evaluation criteria for the ‘dissolving-out’ of charge generating substance and the solubility is as follows.

‘Dissolving-out’ of charge generating substance:

circle: no peak (no dissolving out)

triangle: cannot be determined to be either present or not present

x: peak observed (dissolving out is present)

‘Solubility:’

circle: completely soluble

triangle: partially insoluble, partial precipitation

x: insoluble, precipitation

A total evaluation was conducted with the following evaluation criteria as determined from the dissolving out of the charge generating substance and the solubility factors above. The total evaluation was conducted according to the following standard:

circle: when all of the items were circles

triangle: when circles and triangles were included

x: if there was an x's in any of the items

As shown in Table 1 and 2, MR110 is a charge generating layer binding resin that is especially easily dissolved in solvent. MR110 is insoluble in a mixture solvent of 1,3 dioxolane and toluene, which is therefore preferred as a charge transport layer solvent.

This mixture solvent does not result in poor appearance due to the dissolving of the charge generating layer during charge transport layer film formation. With toluene alone there is no dissolving out of the charge generating layer, but unfortunately since toluene cannot dissolve polycarbonate resin BPPC5 as the charge transport layer binding resin, this is not suitable. Therefore, in total, it can be seen that with a mixture solvent of 1,3 dioxolane and toluene, a mixing amount of 10-80 weight % of toluene is preferable.

In further texts using mixture solvents of 1,3 dioxolane and toluene, measurements regarding dark attenuation and repeat fatigue of photosensitive body 5 with each of the compositions were conducted in the following sequence.

First, in the dark, the surface electric potential was charged by corona discharge to approximately −650 V, and a surface electric potential V0 was measured immediately after charging. Next, the corona discharge was stopped, and the photosensitive body was left in the dark for 5 seconds, and the surface electric potential V5 was measured. Based on the following formula, the electric potential retention rate Vk5 (%) was obtained. Vk5 (%) (V5/V0)×100

Next, using a monochrome light of 780 nm (that has been separated by a filter from the light of a halogen lamp) the light exposure amount required for the surface electric potential to reach −100 V from −600 V was measured as sensitivity E100 (microJoules/cm²). The exposure amount required for the surface electric potential to become −50 V from −600 V was additionally measured as sensitivity E50 (microJoules/cm²).

Where there is light exposure of 5 seconds with a monochrome light of 780 nm at 1.0 microwatt/cm² (separated by a filter from light of a halogen lamp) the value of the surface electric potential was measured as Vr5 (V).

Using a LaserJet 5 (manufactured by Hewlett Packard Corp. Ltd.), before and after repeating 30K sheets, the electric potential when printing a blank sheet (light portion electric potential) and the value of the black print portion as measured by Mcbeth RD918 (black density) were obtained. These results are shown in the following Table 3.

As can be shown from Table 3 above, for the mixture solvent, by increasing the mixing amount of toluene with respect to 1,3 dioxolane, the initial sensitivity is improved and the residual electric potential was reduced. As a

further improvement, even with repeated use, fluctuations in the light portion electric potential and the black printing density are suppressed, and a supprizingly good photosensitive body is achieved.

TABLE 3

| | | | | | | | Repeat Fatigue (30K) | |
|---|---|---|---|---|---|---|---|---|
| Photo- | | | | | | | Light Portion | |
| sensitive | | | EDA | | | | electric | Black |
| body | | | Vk5 | E100 | E50 | Vr5.0 | potential | Density |
| test ex. | Solvent | | % | μJ/cm² | | V | Δ VL (V) | (Δ) |
| 1-1 | 1,3 dioxolane/ | 100/0 | 90.2 | 0.49 | 2.03 | 33 | 15 | −0.05 |
| 1-2 | toluene | 90/10 | 90.3 | 0.44 | 1.42 | 26 | 5 | −0.02 |
| 1-3 | | 70/30 | 90.2 | 0.42 | 1.25 | 23 | 3 | −0.02 |
| 1-4 | | 50/50 | 90.1 | 0.41 | 1.21 | 20 | −1 | −0.02 |
| 1-5 | | 20/80 | 90.2 | 0.42 | 1.23 | 21 | 1 | −0.02 |
| 1-6 | | 0/100 | 90.1 | 0.43 | 1.30 | 23 | 4 | −0.02 |

TABLE 4

| Photo- | | | | | |
|---|---|---|---|---|---|
| sensitive | | EDA | | | |
| body test | Addition of Titanyl | Vk5 | E100 | E50 | Vr5.0 |
| example | phthalocyanine (ppm) | % | μJ/cm² | | V |
| 1-1 | 0 | 90.2 | 0.49 | 2.03 | 33 |
| 9-1 | 100 | 90.3 | 0.44 | 1.42 | 26 |
| 9-2 | 1000 | 90.2 | 0.42 | 1.25 | 23 |
| 9-3 | 10000 | 90.1 | 0.41 | 1.21 | 20 |

### Photosensitive Body Group 9

### Photosensitive Body Test Example 9-1

A photosensitive body was created in the same manner as photosensitive body test example 1-1, except that in the charge transport layer coating solution, 100 ppm of titanyl phthalocyanine was added.

### Photosensitive Body Test Examples 9-2,3

Photosensitive bodies were created in the same manner as photosensitive body test example 9-1, except that the amount of titanyl phthalocyanine added to the charge transport layer coating solution was changed as shown in the following Table 4.

After reviewing the results of Table 4, it is easily seen that when a charge generating substance is added to a charge transport layer, the electrical properties deteriorate in association with an increased mixing amount.

For effectiveness, the coating solvent for charge transport layer must be capable of minimizing ‘debilitating dissolution’ of charge generating layer 3 during application of charge transport layer 4. Debilitating dissolution is dissolution that substantially negatively effects a performance variable of photosensitive body 5 beyond a manufacturer or customer defined limit. To be effective within the meaning of the present invention, the invention must prevent such substantial ‘debilitating dissolution.’ Obviously, some amount of dissolution may or can occur, no matter how small, and is covered within the claimed meaning and without negative impact on performance. Thus, in the present invention, the ‘dissolution’ described in the claims is only that dissolution that creates a substantially debilitating dissolution, and small unimportant dissolution is covered within the claims.

According to the present embodiment of the invention, the coating solution solvent for charge transport layer 4 easily and surprisingly satisfies quality conditions in relation to the components of charge generating layer 3. By doing so the present invention eliminates or greatly minimizes, poor appearance due to dissolving of the charge generating layer and the deterioration in electrical properties, dark attenuation, and repeat fatigue, each resulting from the dissolving of charge generating substance into the charge transport layer. In total, the present invention provides a good photosensitive body 5 that satisfies consumer and manufacturer demands.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for manufacturing an electrophotography photosensitive body, comprising the steps of:
forming at least a charge generation layer on at least a conductive substrate;
said step of forming said charge generation layer including coating a first coating solution containing at least a first charge generating substance, a first binding resin, and a first solvent;
forming at least a charge transport layer on top of said charge generation layer;
said step of forming said charge transport layer including coating a second coating solution containing at least a second charge transport substance, a second binding resin, and a second solvent; and
choosing said second solvent as a solvent effective to prevent a dissolution of said first charge generating substance into said second coating solution during said step of forming at least a charge transport layer.

2. A manufacturing method, according to claim 1, wherein:
said second solvent is a mixture solvent; and
said mixture solvent containing at least 1,3 dioxolane and toluene, whereby said dissolution is minimized.

3. A manufacturing method, according to claim 2, wherein:
said mixture solvent contains toluene in from 10 to 80 weight %.

4. A manufacturing method, according to claim 3, wherein:
said mixture solvent contains toluene in from 10 to 50 weight %.

5. A manufacturing method, according to claim 2, wherein:
said first binding resin includes at least a vinyl chloride copolymer resin.

6. A manufacturing method, according to claim 2, wherein:
said charge transport layer includes an oxidation inhibiting agent, whereby said electrophotography photosensitive body increases in chemical, thermal, and optical stability.

7. A manufacturing method, according to claim 3, wherein:
said step of forming said charge transport layer includes forming said charge transport layer in a first film thickness; and
said first film thickness from 3 to 50 micrometers.

8. A manufacturing method, according to claim 7, wherein:
said first film thickness is preferably from 10 to 40 micrometers.

9. A manufacturing method, according to claim 2, wherein:
said second coating solution is of a type preventing transport of said first charge generating substance from said charge generating layer even after said second coating solution has coated a total area of 2500 meters square during said step of forming said charge transport area.

10. A method for manufacturing an electrophotography photosensitive body, comprising the steps of:
forming at least a charge generation layer on at least a conductive substrate;
said charge generating layer using a first coating solution containing at least a first charge generating substance, a first binding resin, and a first solvent;
forming at least a charge transport layer on top of said charge generation layer;
said charge transport layer using a second coating solution containing at least a second charge transport substance, a second binding resin, and a second solvent;
said second solvent being of a type effective to prevent a dissolution of said charge generation layer into said charge transportation layer during said step of forming at least a charge transport layer;
said second solvent being a mixture solvent; and
said mixture solvent containing at least 1, 3 dioxolane and toluene, whereby said dissolution is minimized.

11. A method for manufacturing an electrophotography photosensitive body, comprising the steps of:
forming at least a charge generation layer on at least a conductive substrate;
forming charge generation layer using a first coating solution containing at least a first charge generating substance, a first binding resin, and a first solvent;
forming at least a charge transport layer on top of said charge generation layer;
said charge transport layer using a second coating solution containing at least a second charge transport substance, a second binding resin, and a second solvent;
said second solvent being of a type effective to prevent a dissolution of said charge generation layer into said charge transportation layer during said step of forming at least a charge transport layer;
said second solvent being a mixture solvent;
said mixture solvent containing at least 1, 3 dioxolane and toluene; and
said mixture solvent contains toluene in from 10 to 80 weight %, whereby said dissolution is minimized.

12. An electrophotography photosensitive body manufacturing method, including processes for forming at least a charge generating layer and a charge transport layer on top of a conductive substrate, wherein:
forming said charge generating layer using a first coating solution containing at least a first charge generating substance, a first binding resin, and a first solvent;
forming said charge transport layer using a second coating solution containing at least a second charge transport substance, a second binding resin, and a second solvent; and
said second solvent for said second coating solution being a solvent of a type which prevents dissolution of said charge generating layer into said second coating solution of said charge transport layer during said process of forming said charge transport layer.

13. A manufacturing method, according to claim 12, wherein:
said first charge generating substance of said charge generating layer surface is not detected from said second coating solution of said charge transport layer even after conducting a dip coating of said charge transport layer onto a total area of 2500 m² or greater of said charge generating layer surface.

14. A manufacturing method, according to claim 12, wherein:
said second solvent for said second coating solution for said charge transport layer is a mixture solvent of 1,3 dioxolane and toluene; and
a mixture amount of said toluene in said mixture solvent is 10-80 weight %.

15. A manufacturing method, according to claim 12, wherein:
said first binding resin for said charge generating layer includes at least a vinyl chloride copolymer resin.
